(19) United States
(12) Patent Application Publication
(10) Pub. No.: US 2003/0014451 A1
(43) Pub. Date: Jan. 16, 2003

(54) Method and machine for scrambling parallel data channels

(75) Inventors: Arye Peyser, Jerusalem (IL); Itai Katz, Rehovot (IL); Itzlk Felman, Zoran (IL)

Correspondence Address: Shahan Islam, Esq., Rosenman & Colin LLP, 575 Madison Avenue, New York, NY, 10022-2585, US

(73) Assignee: OptiX Networks Inc., Weston, MA

(21) Appl. No.: 09/904,277

(22) Filed: Jul. 12, 2001

(51) Int. Cl. G06F 1/02

(52) U.S. Cl. 708/250; 708/256

(57) ABSTRACT

A method and system for generating a pseudo-random bit series based on a given polynomial of order N, for M parallel communication lines using a machine comprising: N flip-flop machines and logic circuit. The flip-flop machines is initialized according to a given series of N bits. The logic circuit calculates a series of the next M+N tits using the N flip flop machines as function of the current N bit series wherein the function is based on two pre-generated equations. These equations are generated by recursive calculation of matrix array of order N*M according the given polynomial equation.

BACKGROUND or THE INVENTION

The present invention is directed to high-speed data transmission and conversion systems and, more particularly, to a system for de/scrambling parallel data channels.

In recent years there have been a significant improvements in the field of date transmission, the rate and capacity of data transmitting have increased dramatically.

The optical fiber technologies development enable transmission of digital data streams at rate of 10 and more gigabit/sec. Channel-Channel technology involves coupling various computer systems together with optical fiber or a fiber channel compatible electrically conductive (copper) cable and allows data transmission between machines separated by relatively great distances.

In digital transmission systems, in order not to use long sequences of ones or zeros for scrambling, it is normal to create pseudo-random series of bits as function of initial binary pattern by means of a scrambler.

Scrambling used to be done serially, accordingly the pseudo-random code are generated in a serial mode.

While a serial scrambler operates satisfactorily, the circuit for its implementation requires an undesirably high speed clock rate and power consumption,

There are known solutions for creating pseudorandom series for parallel communication channels. Common characteristic of these solutions is using matrix transformation for generating the next pseudorandom bits. (See U.S. Pat. Nos. 5,267,316 and 6,158,026). Such solutions use transformation matrix of order M×M (M=number of parallel outputs) for generating the next M bits. Thus, these solutions comprise at least M flop-flop machine. In cases where M is greater then N such solution configuration is inefficient.

Moreover, using more flip-flop machines, result increase in the surface area of the integrated circuit, consequently, increasing manufacturing cost.

It is therefore a primary object of this invention to avoid the limitations of the prior art and provide a parallel scrambling circuit using minimal flip-flop machines for use in transmission systems.

### SUMMARY OF THE INVENTION

A method of generating a pseudo-random bit series based on a given polynomial of order N, for M parallel communication lines using a system comprising: N flip-flop machines and logic circuit said method comprising the steps of: initializing a series of N bits according to given initial values, storing current series of N bits in flip-flop machines, calculating a series of M bits using the N flip flop machines as function of the current N bit series wherein the function is based on first pre-generated equation and calculating the values of the next N bit using the N flip flop machines as function of the current N bit series wherein the function is based an a second pre-generated equation.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is a general diagrammatic representation of old serial machines verses new parallel machines;

FIG. 2 is diagram block Generic machine to generate pseudo-random series of bits by the use of N flip-flops.

FIG. 3 is a diagram block describing the logic operation of pseudorandom generator solution according to the present invention;

FIG. 4 is an illustration of the transformation matrix according to the present invention;

FIG. 5 is a flow-chart of creating the logic functions for generating the pseudorandom bit series;

FIG. 6 is a flowchart describing the machine processing to produce M outputs bit of the pseudo-random series;

FIG. 7 is a diagram block describing OTN serial scrambler (N=116) according to prior art;

FIG. 8 is an illustration of the solution for the OTN scramble (N=16 and M=128) according to the present invention;

FIG. 9 is a diagram block describing OTN serial scrambler (N=7) according to prior art;

FIG. 10 is an illustration of the shortest repeating sequence for the SONET scrambler;

FIG. 11 is a an illustration of the solution for the SONET scrambler (N=7 and M=128) according to the present invention;

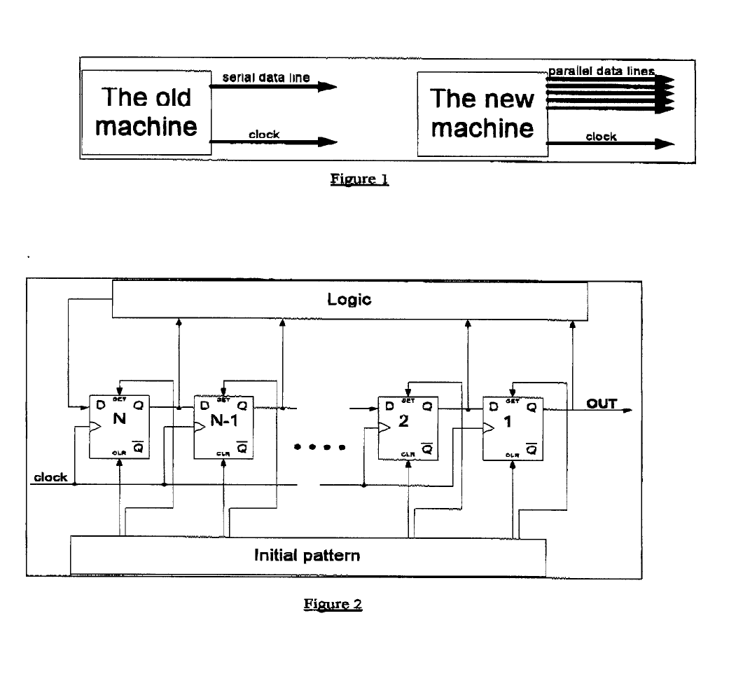

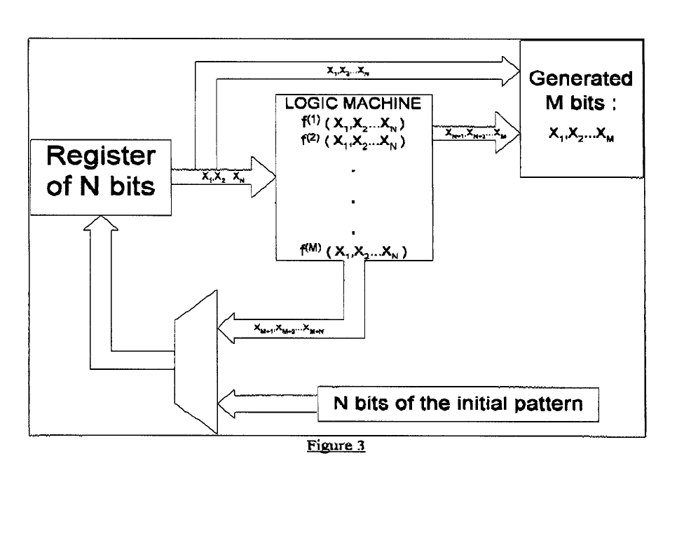

### DETAILED DESCRIPTION OF THE PREFERRED EMBODIMENTS

The embodiments of the invention described herein are implemented as logical operations of logic circuit. The logical operations of the present invention are presented (1) as a sequence of logic implemented steps and (2) as interconnected machine modules within the computing system. The implementation is a matter of choice dependent on the performance requirements of the computing system implementing the invention. Accordingly, the logical operations making up the embodiments of the invention described herein are referred to variously as operations, steps, or modules.

FIG. 2 diagram block describes the configuration of serial scrambler machine according to prior art using N flip-flops components. The machine is provided with initial series of N bits (“Initial Pattern”) and logic circuit conventionally comprising XOR gates. The logic circuit is programmed for computing the next bit of the pseudorandom series as function of the previous N bits at each clock cycle. The flip-flop components are using the initial pattern and “scramble” the next incoming bit at each clock cycle. Such machine is limited for serial stream of bits as it can “scramble” one bit at each clock Cycle. The main restriction of this machine is the pseudorandom series generation as it logic circuit can generated just the single Bit of the series at each clock cycle.

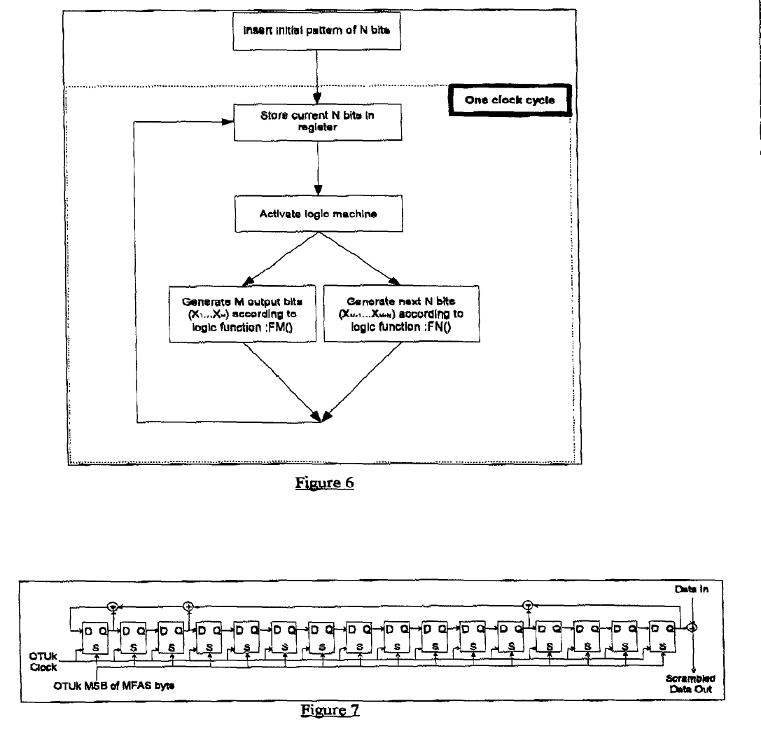

The solution of generating multiple pseudorandom bits each clock cycle is illustrated in FIG. 6.

Let us assume that there are M parallel communication channels for scrambling, accordingly the new machine has to generate M pseudorandom bit each clock cycle. The new machine is provided with same Initial pattern as the old machine, this series of N Bit (X₁, X₂, . . . Xₙ) is stored at the flip-flop machines (“the Register”) component. The new machine further comprises a Logic component based on two pre-generated functions. F(N) and F(M). The F(M) function is programmed to calculate the next M bits of the pseudo number series as function of the previous N bit (X₁, X₂, . . . Xₙ) and the F(N) function is programmed to calculate the next N bits of the pseudo number series as function of the N previous bits (Xₘ₊₁, Xₘ₊₂, . . . Xₘ₊ₙ). The next N bits are stored in the register to feed the logic component at the next clock Cycle. The logic component according to the present invention uses only N flip flop machines and the functions F(N) and F(M) are programmed accordingly.

FIG. 6 flow chart describes the data flow of the new machine at each clock cycle: first the register is updated with the last calculated N bit series, based on this series the logic components generates the next M bits and next N bits according to the functions F(M) and F(N) respectively.

The main concept according to the present invention is to pre-generate the function F(n) and F(m) according technical demands of the scrambling machine comprised of N flip flop machines, wherein the F(M) function generates multiple pseudo number bit simultaneously which are equivalent to the pseudo number bit generation of an old serial machine designed according to the same technical demands.

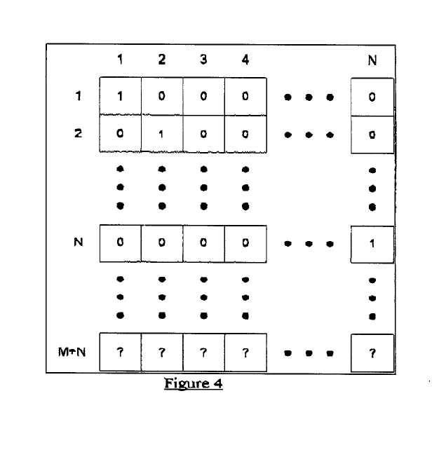

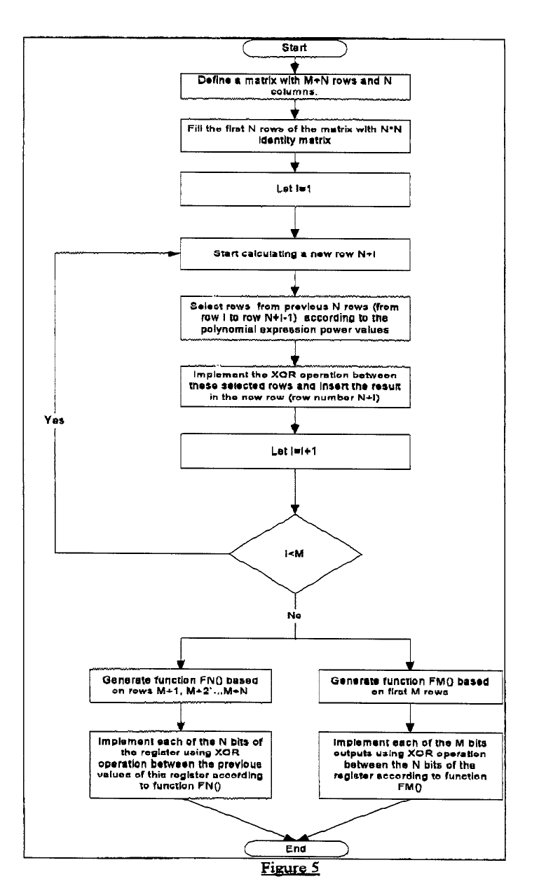

The process of creating the functions F(N) and F(m) is described in FIG. 5. The functions are created out of generated matrix array of bytes of N columns and M rows(as seen in FIG. 4). The first N rows have initial values of unit diagonal matrix having N rows and columns. The creation of the next matrix rows is done by using recursive calculation as function of the previous N rows: first selecting several rows according to their sequential order based on predefined polynomial expression power values. The sequential order of each selected row is determined according to each power value of a given polynomial expression. The next row values are calculated by conducting logic operation on the selected rows. For example, conducting XOR operation on the selected rows. Once all M rows of matrix array (M×N) were calculated the functions of F(N) F(M) are created. The F(M) function is created as result of logic manipulation of the first M rows, the F(N) function is created as result of logic manipulation of rows M+1 till row M+N.

The solution as described above according to the present invention is efficient in case M<(2^{N+1}/N). In case M>(2^{N+1}/N) its is suggested according to the present invention to use a second solution. According to the second solution the next M bits are calculated directly from the new machine register with no further calculation. The register is initialized with values calculated according the shortest repeating sequence of the pseudorandom series.

Example for implementing the Present Invention Method when N=16 and M=128:

Let us assume we have an old machine of OTN scrambler as seen in FIG. 7. Before creating the new machine enabling parallel output, the values of M and N are compared in order to choose the most efficient solution. The values of N and M are inserted to the equation. Because M has a low value according to equation

$$M < \frac{{2}^{N + 1}}{N} = \frac{{2}^{17}}{16} = {2}^{13} ,$$

the solution will be based on the first solution of creating F(N) and F(M) functions.

The old machine, which is described in FIG. 7, was build according to the generating polynomial equitation: X¹⁶+X¹²+X³+X+1.

The Polynomial Equitation is Generated According to the Old Machine as Described in FIG. 7 is: X¹⁶+X¹²+X³+X+1.

Based on this polynomial equitation is created an array matrix of M×N.

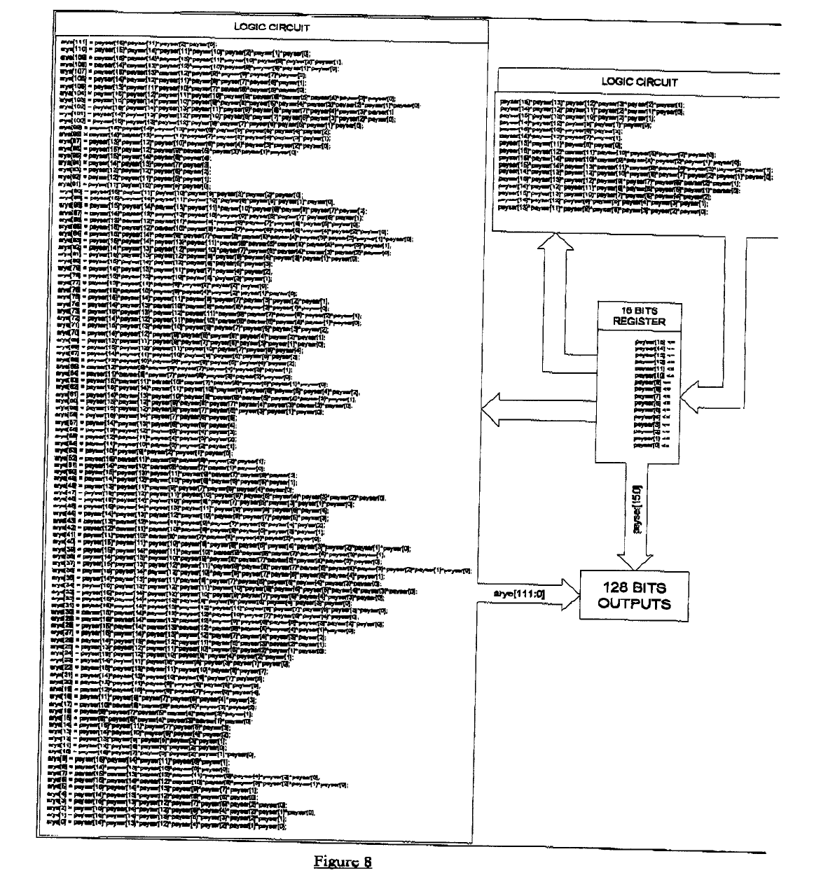

The rows of the matrix are calculated according to the process as described above (FIG. 5). Based on the matrix values the new machine functions are generated as described in FIG. 8.

Example for the Solution when N=7 and M=128

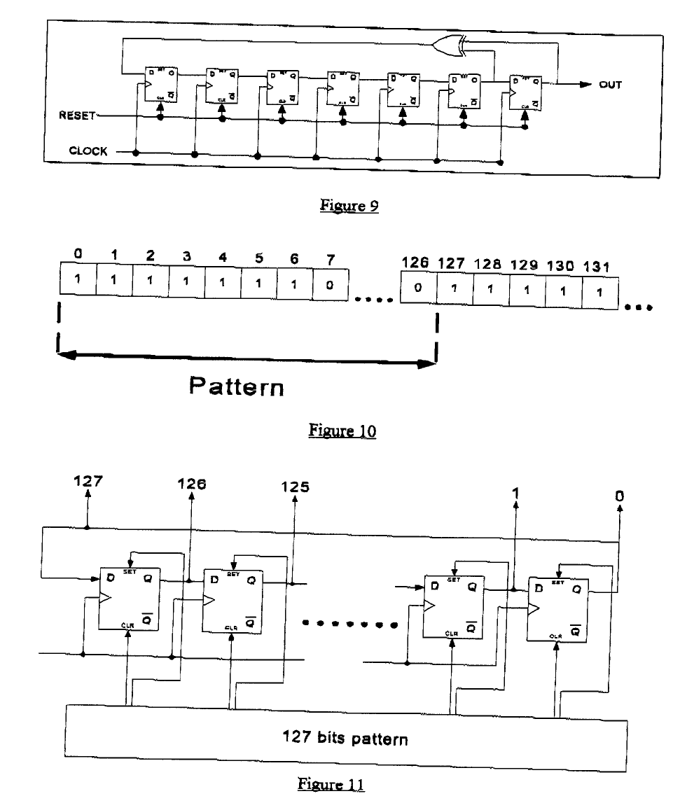

Let us assume we have an old SONET scrambler as described in FIG. 9, which was built according to the generating polynomial X⁷+X⁶+1. Before creating the new machine enabling parallel output, the values of M and N are compared in order to choose the most efficient solution.

The values of N and M are inserted to the equation. Because M has a low value according to equation

$$M > \frac{{2}^{N + 1}}{N} = \frac{{2}^{8}}{7} ,$$

the solution will be based on the second solution according to the present invention, using the shortest repeating sequence of the pseudorandom series of bits.

The Generating Polynomial of the Machine Described in FIG. 9 Shall Be: Equation (7): X⁷+X⁶+1

The length of shortest repeating sequence for this example was found through simulation program to be 127 bits (FIG. 10). According to the present invention the initial sequence of 127 bits is stored in a cyclic register and the 128 output bits are derived from this register as described in FIG. 11. First the machine is initialized according to said sequence of 127 bits. From that point IBM on, the machine 128 outputs produce the correct series of bits and the sequence of bits move through the flip-flops in a cyclic manner.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is;

1. A method of generating a pseudo-random bit series based on a given polynomial of order N, for M parallel communication lines using a system comprising: N flip-flop machines and logic circuit, said method comprising the steps of:
A. Initializing a series of N bits according to given initial values;
B. Storing current series of N bits in flip-flop machines;
C. Calculating a series of the next M bits using the N flip flop machines as function of the current N bit series wherein the function is based on first pre-generated equation;
D. Calculating the values of the next N bit using the N flip flop machines as function of the current N bit series wherein the function is based on a second pre-generated equation;
E. Repeating steps B till D for any new coming M bits;

2. The method of claim 1 wherein the generation of first and second equations is based the given polynomial expression;

3. The method of claim 2 wherein the generation of first and second equations comprise the steps of:
A. Initializing a sequential set of first N rows in matrix array having N columns and M rows according to values of a unit diagonal matrix array having N rows and columns (wherein each row contain single digit of value 1 placed at the respective place according the serial order of the row);
B. Selecting at least two rows from previous N rows according to sequential order based on power values of the polynomial expression;
C. Calculating next row of N bits by conducting logic operation on selected rows;
D. Repeating steps B and C, M times until calculating the total of M+N rows;
E. Generating first equation as manipulation of the first M rows;
F. Generating second equation as manipulation of the rows: M+1, M+2 till M+N.

4. The method of claim 3 wherein the logic operation in step C is XOR.

5. The method of claim 1 further comprising the steps of:
A. Compare the values of M and N according to equation:
$$M < \frac{{2}^{N + 1}}{N} ;$$
B. Perform steps A . . . D of claim 1 in case M<(2^{N+1}/N);
C. Perform the following steps in case M>(2^{N+1}/N);
D. Initializing a series of N bits according to shortest repeating sequence of a given pseudorandom series;
E. Storing current series of N bits in flip-flop machines;
F. Calculating a series of the next M bits as function of the current N bit series;
G. Repeating steps E AND F for any new coming M bits;

6. A machine for generating a pseudo-random bit series base on a given polynomial of order N, for M parallel communication lines, said machine comprising:
A. N flip-flop machines, storing current series of N bits Initialized by first series of N bits according to given initial values;
B. A Logic circuit based on two pre-generated equations (“First equation” and “Second equation”), designated for calculating the next series of M and M+N bits using the N flip flop machines;

7. The method of claim 6 wherein the generation of first and second equations is based on known polynomial expression;

8. The machine of claim 7 wherein the equations are generated by logic machine comprising:
A. First logic component for generating transformation matrix of M*N order wherein each row is generated by recursive calculation as function previous N rows based on the known polynomial expression;
B. Second logic component for generating the first equation as manipulation of the first M rows;
C. Thirds logic component for generating second equation as manipulation of the rows: M+1, M+2 till M+N.

9. The machine of claim 8 wherein the logic circuit comprises XOR logic gates.
